(19) United States
(12) Patent Application Publication
(10) Pub. No.: US 2026/0359436 A1
(43) Pub. Date: Nov. 12, 2026

(54) PREVENTING INVALID MEMORY REFERENCES

(71) Applicant: International Business Machines Corporation, Armonk, NY (US)

(72) Inventors: Richard H. Boivie, Monroe, CT (US); Hani Talal Jamjoom, Cos Cob, CT (US); Alper Buyuktosunoglu, White Plains, NY (US); Tong Chen, Yorktown Heights, NY (US)

(21) Appl. No.: 18/587,741

(22) Filed: Feb. 26, 2024

(51) Int. Cl. G06F 21/55; G06F 21/54

(52) U.S. Cl. CPC G06F 21/556; G06F 21/54

(57) ABSTRACT

A computer-implemented method, according to one approach, includes: generating, in a bounds-checking table, an entry which includes bounds-information that corresponds to an object allocated in memory of a memory device. The CIM also includes writing an address of the object in a first 64 bits of an object pointer, and writing an index of the entry in a second 64 bits of the object pointer, where the object pointer includes 128 bits. An instruction is intercepted that uses the object pointer to load information from or store information to memory. The bounds-information that corresponds to the object pointer is used to execute bounds-checking by: extracting the index of the entry from the second 64 bits of the object pointer. Moreover, the extracted index is used to access the bounds-information from the entry.

### BACKGROUND

The present invention relates to system memory, and more specifically, this invention relates to avoiding invalid memory references.

Applications written in memory-unsafe languages like C or C++ that utilize user-code to explicitly manage memory are vulnerable to memory-safety errors like buffer-overflows, use-after-free, and others. Such errors have previously been exploited in various cybersecurity based attacks. Moreover, such errors are ranked as being some of the most dangerous software issues, and continue to be the root cause of a significant number of vulnerabilities identified in production-software. In particular, errors specific to heap objects, including heap corruption, out-of-bounds accesses, and use-after-free, are associated with causing a number of security issues.

Some attempts have been made to detect or prevent such errors that can broadly be classified as black-listing or white-listing based. Black-listing based approaches prevent some unsafe locations from being accessed, and typically face fewer barriers to adoption such as prohibitive performance overhead or invasive changes to the program source-code. However, black-listing based approaches lack complete coverage, allowing errors to remain undetected, free to be exploited in the wild. In contrast, white-listing based approaches enforce safe program behavior based on authorization and allow more precise enforcement of spatial and temporal memory-safety. However, white-listing based approaches often incur prohibitive slowdowns that can significantly impact throughput. Accordingly, there exists a need to develop a system that is able to efficiently protect against invalid memory references.

### SUMMARY

A computer-implemented method (CIM), according to one approach, includes: generating, in a bounds-checking table, an entry which includes bounds-information that corresponds to an object allocated in memory of a memory device. The CIM also includes writing an address of the object in a first 64 bits of an object pointer, and writing an index of the entry in a second 64 bits of the object pointer, where the object pointer includes 128 bits. An instruction is intercepted that uses the object pointer to load information from or store information to memory. The bounds-information that corresponds to the object pointer is used to execute bounds-checking by: extracting the index of the entry from the second 64 bits of the object pointer. Moreover, the extracted index is used to access the bounds-information from the entry.

A computer program product (CPP), according to another approach, includes: a set of one or more computer-readable storage media, and program instructions. The program instructions are collectively stored in the set of one or more storage media, and are for causing a processor set to perform the foregoing CIM.

A computer system (CS), according to yet another approach, includes: a processor set, and a set of one or more computer-readable storage media. The CS also includes program instructions that are collectively stored in the set of one or more storage media, and are for causing the processor set to perform the foregoing CIM.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a group of conventional bounds-checking based techniques based on a location of their respective bounds-metadata.

FIG. 3A is a block diagram of a system that can facilitate hardware-based memory-error mitigation for heap-objects, in accordance with one approach.

FIG. 3B is a representational diagram of a system that can facilitate memory-error mitigation for heap-objects, in accordance with one approach.

FIG. 4 is a high-level conceptual overview of a life-cycle of a pointer during program runtime, in accordance with one approach.

FIG. 5 is a representational diagram of the organizational layout of hardware and software for a bounds-checking framework, in accordance with one approach.

FIG. 6A is a flowchart of a method, in accordance with one approach.

FIG. 6B is a representational flowchart of sub-processes for one of the operations in the method of FIG. 6A, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for detecting and preventing out-of-bounds memory references as well as use-after-free (also referred to as “dangling pointer”) errors during operation. Unlike other approaches, implementations of the present disclosure involve a hardware-based bounds-checker that can precisely and efficiently enforce object-bounds to prevent spatial errors. Approaches of the hardware-based bounds-checking framework also facilitates efficiently detecting temporal errors such as use-after-free errors, e.g., as will be described in further detail below.

In one general approach, a CIM includes: generating, in a bounds-checking table, an entry which includes bounds-information that corresponds to an object allocated in memory of a memory device. The CIM also includes writing an address of the object in a first 64 bits of an object pointer, and writing an index of the entry in a second 64 bits of the object pointer, where the object pointer includes 128 bits. An instruction is intercepted that uses the object pointer to load information from or store information to memory. The bounds-information that corresponds to the object pointer is used to execute bounds-checking by: extracting the index of the entry from the second 64 bits of the object pointer. Moreover, the extracted index is used to access the bounds-information from the entry.

In another general approach, a CPP includes: a set of one or more computer-readable storage media, and program instructions. The program instructions are collectively stored in the set of one or more storage media, and are for causing a processor set to perform the foregoing CIM.

In yet another general approach, a CS includes: a processor set, and a set of one or more computer-readable storage media. The CS also includes program instructions that are collectively stored in the set of one or more storage media, and are for causing the processor set to perform the foregoing CIM.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved bounds-checking code at block 150 for detecting and preventing out-of-bounds memory references as well as use-after-free (also referred to as “dangling pointer”) errors during operation, e.g., as will be described in further detail below. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

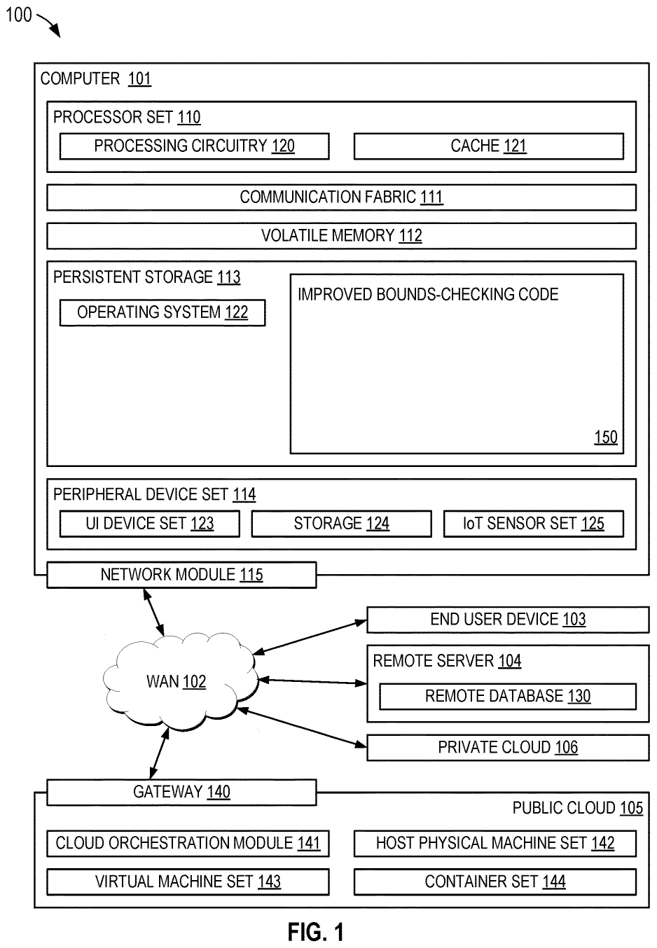

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

Applications written in memory-unsafe languages like C or C++, that utilize user-code to explicitly manage memory, are vulnerable to memory-safety errors like buffer-overflows, use-after-free, and others. Such errors have previously been exploited in numerous attacks, including high-profile attacks, such as the Morris worm and Heartbleed. Moreover, such errors are ranked by MITRE to be some of the most dangerous software issues, and continue to be the root cause of a significant number of vulnerabilities identified in production-software. In particular, errors specific to heap objects, including heap corruption, out-of-bounds accesses, and use-after-free, are associated with causing nearly half of the security issues maintained in common vulnerabilities and exposures (CVE) databases.

Previous attempts have been made to detect or prevent such errors that can broadly be classified as black-listing or white-listing based. Black-listing based approaches prevent (some) unsafe locations from being accessed (e.g., by inserting trip-wires around objects), and typically face fewer barriers to adoption such as prohibitive performance overhead or invasive changes to the program source-code. However, black-listing based approaches lack complete coverage, allowing some errors to remain undetected, free to be exploited in the wild. In contrast, white-listing based approaches enforce safe program behavior based on authorization (e.g. bounds-checking mechanisms that verify that all pointer defererences are within object-bounds) and allow more precise enforcement of spatial and temporal memory-safety. However, white-listing based approaches often incur prohibitive slowdown that can range from about 24% to about 116% slowdown. Moreover, white-listing based approaches often require disruptive changes to source-code or binary-layout, making them difficult to adopt.

As discussed above, applications written in C/C++, where pointer manipulation is permissible without safety-checks, are prone to memory-errors where pointers dereference invalid memory regions. A spatial error (out-of-bounds access) can arise from pointer-arithmetic using unvalidated inputs that causes a buffer-pointer to access memory beyond the buffer-bounds. Similarly, a temporal error (e.g. use-after-free) can result from a read or write using a dangling pointer (a pointer to a freed object whose memory has been subsequently re-used). Memory leakage and corruption due to such errors has been exploited by attacks that break data-confidentiality, attempt privilege escalation, break system-integrity, and the like. Enforcing memory safety and preventing memory errors can facilitate preventing such attacks on production-software. Various techniques can be implemented to enforce memory safety and prevent memory errors.

Such techniques include probabilistic techniques that can either use trip-wires, randomization, or tagged-memory to probabilistically detect memory accesses that cross object-bounds. Trip-wire based techniques generally insert red-zones or trip-wires around objects to detect common spatial bugs that go beyond object-bounds by a small amount. Randomization based techniques generally randomize the memory layouts with the support of the memory-allocator to make bugs easy to detect. Moreover, hardware-based memory-tagging techniques generally assign random 4-bit tags or “colors” to object-pointer pairs to facilitate probabilistically detecting bugs based on “color” mismatches. While relatively easy to adopt due to minimal slowdown or compatibility issues, probabilistic techniques may be unable to provide complete coverage for error-detection by design.

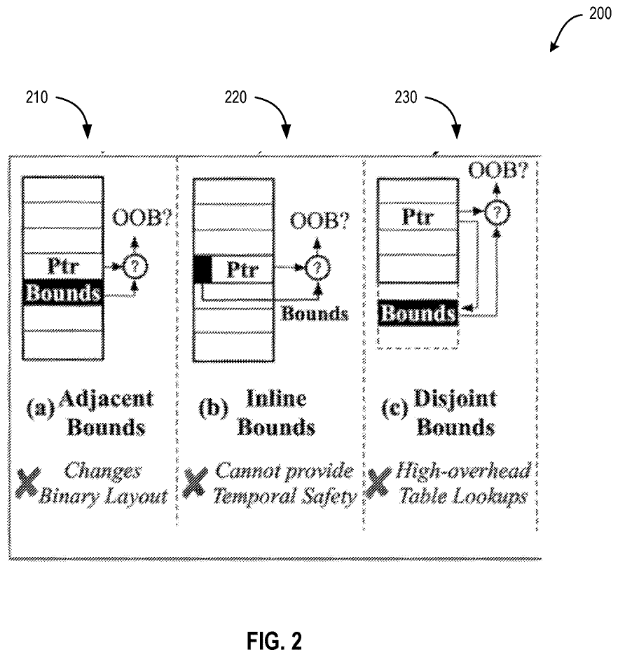

Such techniques can also include bounds-checking based techniques that can provide precise enforcement of safe program behavior by tracking the object base and bounds and enforcing bounds-checks on all object accesses. As illustrated in FIG. 2, conventional bounds-checking based techniques 200 can be grouped based on the location of their respective bounds-metadata. For example, bounds-checking based techniques 200 include an adjacent bounds group 210 that comprises fat-pointer based techniques like CCured and Cyclone. Fat-pointer based techniques can store the base and bounds metadata in separate words alongside the actual pointer value. Such storage of the base and bounds metadata facilitates allowing execution of a bounds-check to detect spatial errors when the actual pointer is dereferenced. In a similar vein, some instances of fat-pointer based techniques can replace pointers with 256-bit “capabilities” that can include the address, bounds-information, permission bits and other metadata required to facilitate enforcing fine-grain compartmentalization along with bounds-checking. Unfortunately, the adjacent bounds group 210 of bounds-checking based techniques generally involve changes to the source code and also changes to the binary layout impacting compatibility with library code.

An inline bounds group 220 of bounds-checking based techniques comprising Low-Fat-pointer based techniques provides another example. Low-Fat-pointer based techniques can encode the object-bounds inline within the pointer, without impacting binary layout. One instance of a low-fat-pointer based technique can use a compact floating-point format to store (the least significant bits of) the object base and bounds addresses in the top 18 bits of a previous 64-bit pointer. Other instances of low-fat-pointer based techniques can allocate objects in size-specific partitions of memory at a size-aligned base-address, to implicitly encode the base and bounds in the pointer-value. These instances of low-fat-pointer based techniques can track pointer-arithmetic (either in hardware or via explicit instructions inserted by compiler/instrumentation) to ensure that the pointer never crosses the inline-bounds. Unfortunately, the inline bounds group 220 of bounds-checking based techniques generally do not provide temporal safety, as the inserted checks that use the bounds within a dangling pointer continue to pass, even after the memory it references is re-used.

A disjoint bounds group 230 of bounds-checking based techniques provides another example. Bounds-checking based techniques within the disjoint bounds group 230 can store bounds-metadata (per pointer or per object) in a disjoint table in shadow-memory to avoid changing the binary layout. The bounds-table is typically indexed using the pointer-value, as a linear table lookup or using a multi-level trie lookup. Such bounds-checking based techniques can detect spatial errors (some designs also detect temporal errors) by executing a bounds-check with a table-lookup (inserted by software or implicitly by hardware) on pointer-dereferences or on all pointer-arithmetic. Purely software-based techniques within the disjoint bounds group 230 that involve extra instructions to propagate bounds-metadata on pointer-arithmetic and for table-lookups can incur high performance overheads (e.g., between about 50% and about 112% on average). Hardware-based techniques within the disjoint bounds group 230 can incur lower overheads compared to the software-based techniques by propagating bounds and executing checks using micro-code or dedicated hardware. However, such hardware-based techniques can continue to incur moderate-to-high slowdown due to expensive table-lookups using the pointer-value, to access the bounds-metadata.

Unlike the various conventional memory safety techniques discussed above, implementations of the present disclosure involve a hardware-based bounds-checker that can precisely enforce object-bounds to prevent spatial errors and temporal errors. Approaches of the hardware-based bounds-checking framework facilitate efficiently invalidating bounds for dangling pointers to detect temporal errors. For practical adoption, approaches of this hardware-based bounds-checking framework comprise low performance overheads and minimize changes to the binary layout. To that end, implementations of the present disclosure involve a bounds-metadata design that can associate a pointer with a unique inline identifier that can be used to index into a disjoint bounds-information table (also referred to herein as a “bounds table”).

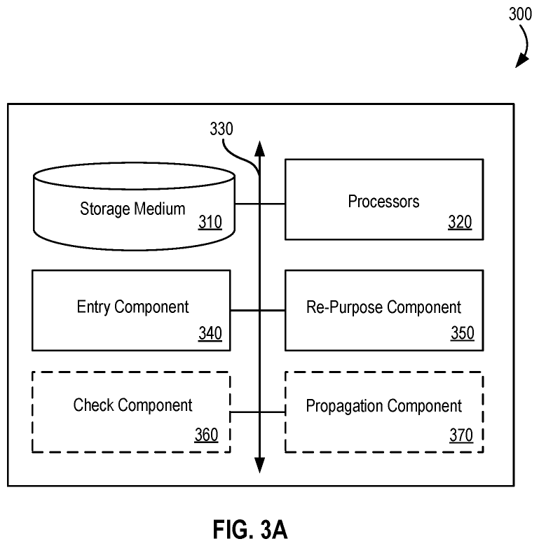

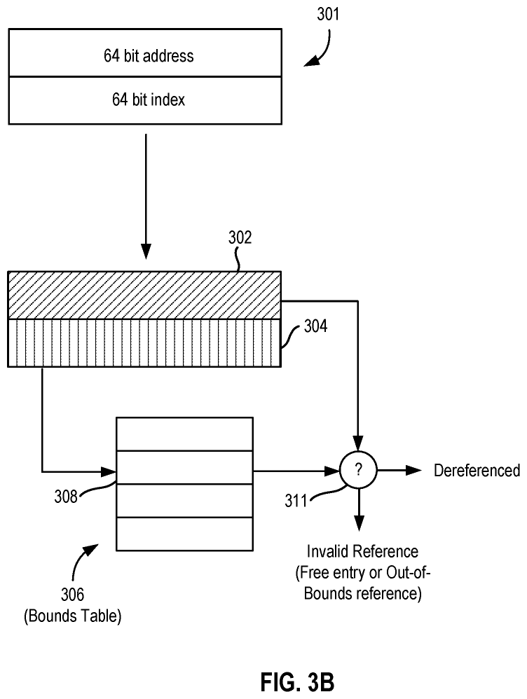

FIG. 3A illustrates a block diagram of an example, non-limiting system 300 that can facilitate memory-error mitigation for heap-objects, in accordance with one or more approaches described herein. System 300 includes non-transitory computer readable storage medium (storage medium) 310 for storing computer-executable components and one or more processors 320 operably coupled via one or more communication busses 330 to storage medium 310 for executing the computer-executable components stored in storage medium 310. As shown in FIG. 3A, the computer-executable components include: entry component 340 and re-purpose component 350.

Entry component 340 can allocate an entry in a table to store bounds-information when an object is allocated in memory. Re-purpose component 350 can re-purpose unused bits of an object address to store an index to the table entry. In an approach, re-purpose component 350 can utilize un-used bits in the object address to track a range of memory addresses that can be accessed.

In an approach, the computer-executable components stored in storage medium 310 can further include check component 360. Check component 360 can execute bounds-checking in hardware on load and store instructions by using index bits in an address to access the bounds-information. In an approach, check component 360 can check array bounds. In an approach, check component 360 can determine if an array reference is in-bounds or out-of-bounds and mitigates occurrence of out-of-bounds array references.

In an approach, the computer-executable components stored in storage medium 310 can further include propagation component 370. Propagation component 370 can automatically propagate the index when subsequent object addresses are derived via assignment statements or pointer arithmetic. In an approach, propagation component 370 can propagate extra information in unused bits in certain situations, e.g., such as when the object address is copied in an assignment statement, passed in a function call, used to compute another address in array indexing or pointer arithmetic, etc. In some approaches, propagation component 370 can propagate extra information in unused bits when the object address is passed as an argument in a function call. In an approach, propagation component 370 can propagate extra information in unused bits when the object address is used to compute an address in array indexing or pointer arithmetic. The functionality of the computer-executable components utilized by the approaches will be covered in greater detail below.

The following disclosure presents a low-cost and minimally invasive framework for bounds-checking in hardware. The disclosed techniques involve a hardware-enabled pointer bounds-checking framework, for low-cost yet precise enforcement of memory safety for heap-objects. Moreover, the size of the object pointers used to perform the bounds-checking is sufficiently large that the approaches herein may support applications of extremely large size. For instance, using object pointers that are 128 bits in length allows for a significant number of objects to coexist without overlapping. In an approach, the disclosed bounds-checking framework for heap-objects can be implemented using LLVM-instrumentation to replace malloc/free calls in programs with custom library-functions for maintaining bounds-information.

As discussed in greater detail below, implementations of the disclosed techniques facilitate mitigating memory-errors for heap-objects using precise enforcement of object-bounds on pointer-dereferences, to prevent out-of-bounds access and use-after-free errors. The disclosed techniques facilitate precise enforcement of such object-bounds while ensuring minimal performance impact and can be implemented with minor or no changes to source-code or binary layout. Approaches of the disclosed techniques can mitigate memory-errors for heap-objects by re-thinking hardware-enforced bounds-checking in a vertically integrated hardware/software (HW/SW) eco-system, with minimal changes to C/C++ memory-allocation functions, instruction set architecture (ISA), and hardware.

One aspect of the disclosed techniques involves implementing object pointers of a length that permits virtually universal application. As noted above, using 128 bit object pointers allows for a significant number of objects to coexist without overlapping. Moreover, approaches are able to provide extensions that support memory-safety protection for objects on the stack and for global objects. However, it should be noted that protection for stack objects and global objects as described in the present disclosure is also applicable to 64 bit pointers, e.g., as would be appreciated by one skilled in the art after reading the present description.

Another aspect of the disclosed techniques involves re-purposing the “unused bits” in a pointer to check or keep track of a range of addresses that can be legitimately accessed via the pointer. Object-pointers typically have unused bits, as they generally store virtual-addresses with 48 bits of information or less, which is significantly less than the length of the 128 bit object pointers described herein. The disclosed techniques can thereby leverage these unused bits to: (a) allocate an entry in a bounds-table to store the bounds-information when an object is allocated; (b) re-purpose the unused bits (e.g., bottom bits) of the object-pointer to store the index to the bounds-table entry; (c) automatically propagate the index when subsequent addresses are derived via assignment statements or pointer arithmetic; and/or (d) execute bounds-checking in hardware on load and store instructions by using the index bits in an address to access the appropriate bounds-information. By leveraging these unused bits, the disclosed techniques facilitate a spatial and temporal safety solution for heap-objects, which prevents errors like heap out-of-bounds reads and writes, and use-after-free. In addition to mitigating heap-errors, one or more approaches of the disclosed techniques are also generally applicable to memory safety for global and stack-objects.

For example, FIG. 3B illustrates a non-limiting high-level conceptual overview of re-using unused bits (e.g., bottom bits) of an object-pointer to enforce spatial and temporal safety for heap-objects, in accordance with one or more approaches described herein. As shown, the disclosed techniques generally re-purpose unused bits (e.g., bottom bits) of a long object-pointer to store an index of an entry in a bounds-information table containing bounds-metadata corresponding to the object-pointer. The 128 bit long object pointer 301 is used to store the address of an object in a first 64 bits 302 of the object pointer, and a second 64 bits 304 of the object pointer is used to store an index of an entry in a bounds-information table that corresponds to the object. In one approach, the bounds-information table is a per-process table. In some approaches, the disclosed techniques intercept C-library memory allocation functions to allocate an entry in a bounds-information table on a malloc and invalidate the entry on a free.

As further illustrated by FIG. 3B, the 128 bit long object pointer 301 may be used in combination with a bounds-information table 306 to facilitate checking or tracking the bounds-metadata for each object on the heap. For instance, an instruction may be intercepted that includes an object pointer 301 which may be used to load information from or store information to memory. As noted above, the second 64 bits 304 of the object pointer 301 may be used to store an index of an entry in a bounds-information table that corresponds to the object. Accordingly, bounds-checking may be performed by extracting the index of the entry from the second 64 bits 304 of the object pointer 301. The extracted index may thereby be used to access bounds-information stored in a corresponding entry 308 of the bounds-information table 306.

Metadata extracted from the corresponding entry 308 of the bounds-information table 306 can be used to enforce bounds-checks on pointer-dereference via bounds-checking operations in load/store execution in hardware. Accordingly, decision 311 determines whether an invalid pointer dereference is detected, indicating for example that an out-of-bounds reference error has occurred. It follows that approaches herein are able to detect out-of-bounds accesses during the lifetime of an object by using an index of a bounds-table entry in the unused bits (e.g., bottom bits) of an object-pointer. Decision 311 may also be able to identify other invalid memory references via information in the bounds-information table 306. After an object is freed, the disclosed techniques herein are able to detect use-after-free errors using the index in a dangling-pointer that points to an invalid bounds-table entry. Accordingly, decision 311 is able to identify use-after-free situations after an object has been freed.

Of note, the disclosed techniques can detect and prevent use-after-free errors, unlike prior fat-pointer based approaches. Additionally, the disclosed techniques do not incur any overheads for propagation of the index (which can happen “automatically” via program semantics) when one pointer is assigned to another or passed in a function call, or used to compute another address in array indexing or pointer arithmetic. In contrast, conventional products involve extra instructions or micro-ops to propagate pointer-metadata. Again, approaches herein are able to propagate the index “automatically” without any “extra” instructions being fetched or executed.

Moreover, the performance impact of the actual bounds-checking can be minimal for, at least, two reasons. First, since all the addresses associated with a given buffer can have the same index, the index bits and the bounds-information for an address will often be available in an on-chip Bounds-Information (BI) cache. Second, the bounds-checking for a load or store operation can be done in parallel with the address translation of the load or store operation, often without adding any extra delay to the load or store instruction. Lastly, as the location of the bounds-information (which can be determined by the index) is independent of the pointer-value, the disclosed techniques can also maintain invalid-bounds status for dangling pointers even after the freed memory is reused. The disclosed techniques can also provide temporal safety at no extra cost, unlike existing hardware-based bounds-checking solutions where the bounds-metadata location is generally linked to pointer-value.

In an approach, the disclosed bounds-checking framework for heap-objects can address a threat model comprising one or more assumptions. One example assumption can be that a program may have heap memory-safety bugs like out-of-bounds access, use-after-free, double-free, and invalid-free. Another example assumption is that an adversary can pass unverified inputs to the program in an attempt to exploit such memory bugs. Another example assumption is that an adversary cannot modify the user-program code to introduce bugs, or directly access or tamper bounds-metadata. Another example assumption is that the memory-allocator functions that can be used by the disclosed framework to manage the bounds-metadata are trustworthy and bug-free.

One aspect of the disclosed bounds-checking framework is to store the bounds-metadata of an object throughout its lifetime in a bounds-information table, in a virtual address space of a program. In an approach, the bounds-information table is a per-process bounds-information table. Another aspect of the disclosed bounds-checking framework is to enforce hardware-based bounds-checks on all object accesses at runtime.

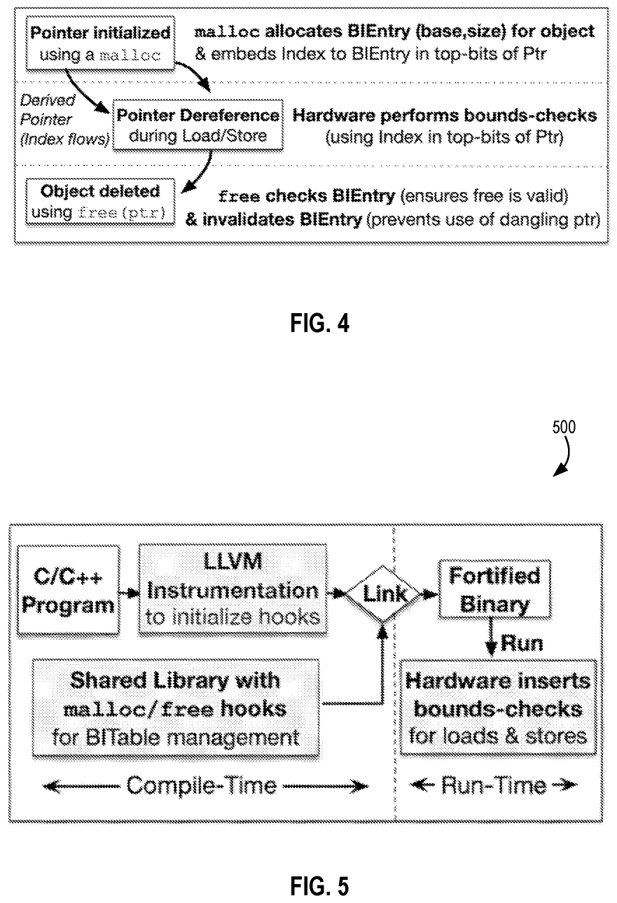

FIG. 4 illustrates an example, non-limiting high-level conceptual overview of a life-cycle of a pointer during program runtime, in accordance with one or more approaches described herein. As illustrated in FIG. 4, an entry can be created in the bounds-information table in response when an object is created. The entry in the bounds-information table can be used to store a base-address and a size of the corresponding object. In another approach, an entry in the bounds-information table can be used to store the addresses that correspond to the upper and lower bounds of the corresponding object. An index of the corresponding entry of the bounds-information table can be embedded within unused bits of the pointer to the object. As used herein, the term “index bits” refers to unused bits of a pointer in which an index of a corresponding entry of a bounds-information table is embedded.

For simplicity of implementation, the following disclosure describes the top 64 bits of a 128 bit long pointer as being used to store the address of an object, while the bottom (e.g., next) 64 bits of a 128 bit long are used to store the index of the entry in a bounds-information table that corresponds to the object. However, this is in no way intended to be limiting. For example, use of the terms “first” and “second” herein is in no way intended to be limiting. In some approaches, the “first” 64 bits of a 128 bit object pointer may include bit 0 through bit 63, while a “second” 64 bits of the object pointer includes bit 64 through bit 127. However, other configurations may be implemented depending on the approach. In other approaches, a “first” 64 bits of a 128 bit object pointer may include bit 64 through bit 127, while a “second” 64 bits of the object pointer includes bit 0 through bit 63. In still other approaches, a “first” 64 bits may include an arbitrary combination of bits from the 128 bit object pointer, while the “second” 64 bits includes the remaining bits. Again, any desired configuration may be implemented.

It should also be noted that while approaches herein are described as using 128 bit object pointers, this is in no way intended to be limiting. For instance, in some approaches, a single design can support programs that use 128 bit long pointers and programs that use 64 bit pointers. Such a design preserves the advantages associated with programs that use 64 bit pointers (e.g., no changes to source code or binary layout, compatibility with existing libraries and minimal performance impact) while also enabling protection of programs that include an extremely large number of objects or an extremely large amount of virtual address space. Importantly, such a design enables concurrent support of both kinds of programs on a single system, and a “make flag” can be used at compile-time to make a memory-safe program with either 64 bit pointers or 128-bit “long pointers” as referred to herein.

Furthermore, approaches of the present disclosure are not limited to the index bits being either contiguous or the bottom 64 bits of the object pointer. In one approach, the index bits are non-contiguous. In an approach, one or more bits (e.g., don't care bits) may follow the index bits in the object pointer. FIG. 4 further illustrates that hardware can use the index within the object pointer to access the corresponding bounds-information table entry and perform a bounds-check to detect out-of-bounds accesses in response to the pointer being dereferenced. Moreover, as illustrated in FIG. 4, the corresponding entry in the bounds-information table can be invalidated in response to an object being freed. Invalidating corresponding bounds-information table entries can facilitate detection of temporal errors if dangling pointers to such freed objects are used subsequently.

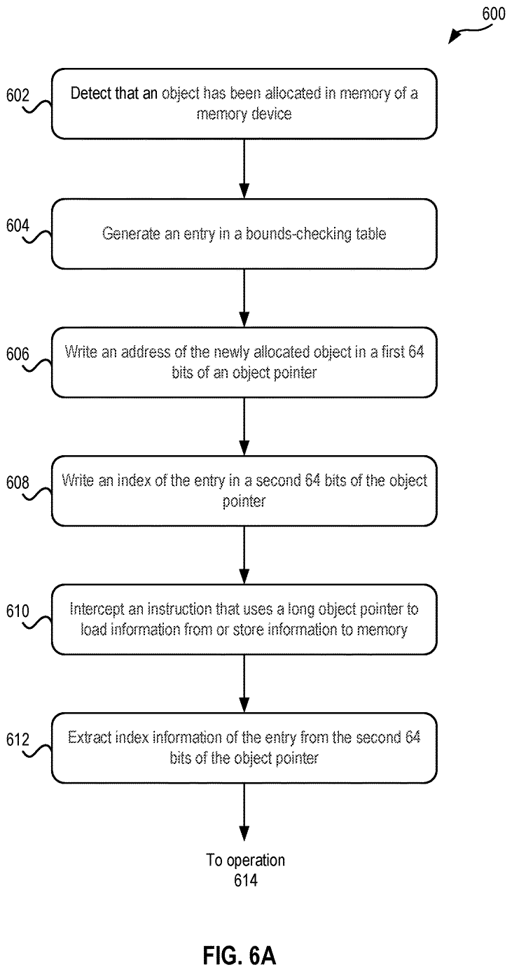

Looking now to FIG. 5, a non-limiting organizational layout 500 of a bounds-checking framework is illustrated in accordance with one or more approaches described herein. As shown, software elements can manage the bounds-information table. For example, hooks for malloc and free functions can be used to intercept calls to these functions and to perform associated bounds-information table operations, such as allocation and invalidation of entries in the bounds-information table. Such hooks can be defined in a shared-library that can be added by the linker during program compilation. Moreover, such hooks can be added during program compilation without making any significant changes to the source-code and with minimal compatibility issues due to changes to the binary layout. FIG. 5 further illustrates that hardware elements, on which this binary runs, can transparently execute the bounds-checks for every load instruction and/or store instruction to detect memory safety violations. Load instruction and/or store instruction execution can be modified in hardware to also access the bounds-information table and obtain the bounds-metadata for a bounds-check. A bounds-information cache can also be added to limit any slowdown from accesses to the bounds-information table in memory.

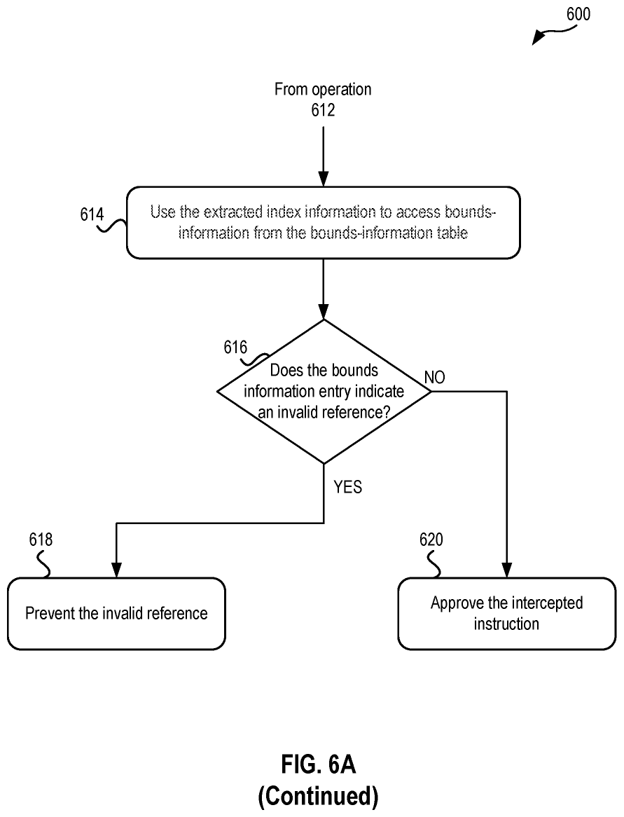

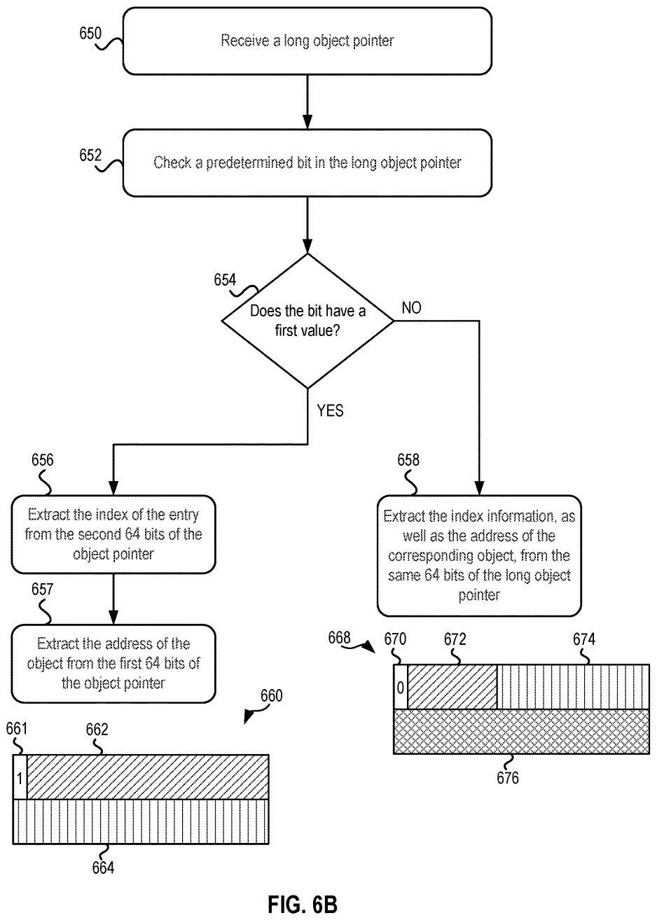

Referring now to FIG. 6A, a computer-implemented method 600 for detecting and preventing out-of-bounds memory references as well as use-after-free errors during operation, is illustrated in accordance with one approach. The method 600 may be performed in accordance with the present invention in any of the environments depicted in FIGS. 1-5, among others, in various approaches. For instance, one or more operations in method 600 may be performed by components in the system 300 of FIG. 3A. Moreover, more or less operations than those specifically described in FIG. 6A may be included in method 600, as would be understood by one of skill in the art upon reading the present descriptions.

Each of the steps of the method 600 may be performed by any suitable component of the operating environment using known techniques and/or techniques that would become readily apparent to one skilled in the art upon reading the present disclosure. For example, in various implementations, the method 600 may be partially or entirely performed by a controller, a processor, one or more artificial intelligence-based models, etc., or some other device having one or more processors therein. The processor, e.g., processing circuit(s), chip(s), and/or module(s) implemented in hardware and/or software, and preferably having at least one hardware component may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 6A, operation 602 of method 600 includes detecting that an object has been allocated in memory of a memory device. In other words, operation 602 includes receiving an indication that a new object has been allocated in memory. Depending on the approach, the new object may be allocated in response to receiving one or more instructions from a user, automatically in response to request(s) received from a running application, in response to a predetermined condition being met (e.g., no available objects), etc.

In response to detecting that an object has been allocated in the memory, method 600 advances to operation 604. There, operation 604 includes generating an entry in a bounds-checking table. The entry created in the bounds-checking table preferably includes bounds-information that corresponds to the newly allocated object in memory. In other words, the created entry in the bounds-checking table is used to store metadata that corresponds to (e.g., describes characteristics of) the newly allocated object in memory.

Proceeding to operation 606, there method 600 includes writing an address of the newly allocated object in a first 64 bits of an object pointer. In other words the address in memory where the object has been newly allocated is stored in a first 64 bits of the object pointer. Moreover, operation 608 includes writing an index of the entry in a second 64 bits of the object pointer. In other words, an index at which the entry corresponding to the newly allocated object is found in the bounds-checking table is also stored in the object pointer. It follows that the object pointer used to store the address and index includes (e.g., has a length of) at least 128 bits. While some approaches implement object pointers having a length of 128 bits, any desired length may be implemented.

It should also again be noted that use of the terms “first” and “second” as used herein is in no way intended to be limiting. For instance, in some approaches the “first”64 bits of a 128 bit object pointer may include bit 0 through bit 63, while a “second” 64 bits of the object pointer includes bit 64 through bit 127. However, other configurations may be implemented depending on the approach. In other approaches, a “first” 64 bits of a 128 bit object pointer may include bit 64 through bit 127, while a “second” 64 bits of the object pointer includes bit 0 through bit 63. In still other approaches, a “first” 64 bits may include some combination of bits from the 128 bit object pointer, while the “second”64 bits includes the remaining bits. Again, any desired configuration may be implemented.

It follows that operations 602, 604, 606, 608 may be repeated each time a new object is allocated in memory. Method 600 further advances from operation 608 to operation 610 in response to identifying an instruction that uses (e.g., includes) an object pointer. Looking specifically to operation 610, there method 600 includes intercepting an instruction that uses a long object pointer to load information from or store information to memory. It follows that the intercepted instruction may use a different long object pointer than the one formed above. According to preferred approaches, the long object pointer includes at least 128 bits. Moreover, the first 64 bits of the object pointer may include the address of a respective object in memory, while a second 64 bits of the object pointer include a corresponding index in a bounds-information table, e.g., as described above.

It follows that this long object pointer may be extracted from the intercepted instruction, and used to perform bounds-checking. Accordingly, method 600 proceeds from operation 610 to operation 612, where the index information of the entry is extracted from the second 64 bits of the object pointer. The extracted index information may be examined and used to access a corresponding entry in the bounds-information table. Accordingly, operation 614 further includes using the extracted index information to access bounds-information from the corresponding entry in the bounds-information table.

In response to obtaining the bounds-information from the corresponding entry in the bounds-information table, method 600 advances from operation 614 to operation 616. There, operation 616 includes using the bounds-information to determine whether it indicates a free entry or out-of-bounds reference. In other words, the bounds-information is used to determine whether the intercepted instruction references an object that is out-of-bounds and/or a free entry. Operation 616 uses the bounds-information to determine whether the intercepted instruction references an object that is in-bounds or out-of-bounds (e.g., see decision 311 in FIG. 3B). It follows that this determination may be made by inspecting any metadata included in the referenced bounds-information table entry, e.g., as would be appreciated by one skilled in the art after reading the present description.

In response to determining that a reference to an object is invalid (e.g., out-of-bounds and/or free entry), method 600 advances from operation 616 to operation 618. There, operation 618 includes preventing the invalid reference. In other words, operation 618 includes mitigating the invalid reference to an out-of-bounds object and/or a free entry. In some approaches, this may be done by replacing the reference to the out-of-bounds object, with a reference to an in-bounds object. This effectively replaces the faulty portion of the instruction that uses the object pointer without negatively impacting performance of the system as a whole. Alternatively, method 600 advances from operation 616 to operation 620 in response to determining that the reference to the object is in-bounds. There, operation 620 includes approving the intercepted instruction, e.g., such that it is satisfied (or performed). In other words, operation 620 includes accessing the address of the object listed in the object pointer.

Again, by implementing long object pointers having a length of 128 bits or more, approaches herein are desirably able to achieve a low-cost and minimally invasive framework for bounds-checking in hardware. Method 600 achieves a hardware-enabled pointer for bounds-checking framework that is able to perform low-cost, yet precise enforcement of memory safety for heap-objects. Moreover, the size of the object pointers used to perform the bounds-checking is sufficiently large that the approaches herein may support applications of extremely large size. Again, using object pointers that are 128 bits in length allows for a significant number of objects to coexist without overlapping. Furthermore, the techniques disclosed in the approaches herein facilitate mitigating memory-errors for heap-objects using precise enforcement of object-bounds on pointer-dereferences, to prevent out-of-bounds access and use-after-free errors. The disclosed techniques facilitate precise enforcement of such object-bounds while ensuring minimal performance impact and can be implemented with minor or no changes to source-code or binary layout.

However, it should be noted that while method 600 is described in the context of object pointers using the first 64 bits to store the address of a respective object in memory and using a second 64 bits of the object pointer to store a corresponding index in a bounds-information table, this is in no way intended to be limiting. For instance, object-pointers generally store virtual-addresses with 48 bits of information or less. It follows that there are situations where the first 64 bits (or equivalently the last 64 bits, partitioned bits that total 64 bits, a randomly assigned 64 bits, etc.) may be used to store the address of the object as well as the index of the corresponding entry in the bounds-information table. In other situations, the index value and/or address of an object may be sufficiently large that they may not both be stored in the same 64 bits of the long object pointer.

It is desirably to differentiate long object pointers that have an object address and bounds-information table index in the same 64 bits, from long object pointers that have an object address and bounds-information table index stored in different halves (e.g., portions) of the full pointer. According to some approaches, a predetermined one (or more) of the 128 bits in a long object pointer may be used to distinguish between the different configurations. For instance, a first bit in a 128 bit long object pointer may be predetermined as identifying the configuration of the information stored in the object pointer.

Looking now to FIG. 6B, exemplary sub-operations of inspecting the information in an object pointer are illustrated in accordance with one approach. For instance, the sub-operations of FIG. 6B may be used to identify the address of an object and the index of a corresponding entry in a bounds-information table. It follows that one or more of the sub-operations in FIG. 6B may be used to perform any of the operations (e.g., at least operations 612, 614) of FIG. 6A. However, it should be noted that the sub-operations of FIG. 6B are illustrated in accordance with one approach which is in no way intended to limit the invention.

As shown, sub-operation 650 includes receiving a long object pointer. According to some approaches, an instruction may be intercepted that includes the long object pointer. In other approaches, the long object pointer may be received differently. In response to receiving the long object pointer, the flowchart proceeds to sub-operation 652.

There, sub-operation 652 includes checking a predetermined one of the bits in the long object pointer. As noted above, some approaches may use a predetermined one of the bits in a 128 bit long object pointer to indicate how the information therein is organized. In some approaches, the first bit in the 128 bit long object pointer may be predetermined (e.g., designated) as identifying the location of index information and the location of an address of a respective object. For example, situations where the first bit of the 128 bit long object pointer has a value of “1” may be used to indicate that the index into the bounds-information table cannot fit in a same 64-bit portion (e.g., half) of the long object pointer as the object address. However, situations where the first bit of the 128 bit long object pointer has a value of “0 ” may be used to indicate that the index into the bounds-information table can fit in a same 64-bit portion (e.g., half) of the long object pointer as the object address. It follows that the value of the predetermined (e.g., first) bit in the 128 bit long object pointer provides valuable insight on the contents of the long object pointer.

In some approaches, a two bit tag may be used to indicate the contents of the long object pointer. For example, a tag having a value of “00” may indicate a remaining 62 bits of the first 64 bits in the pointer points to an “ordinary” address (with no bounds checking). Moreover, a tag having a value of “01” may indicate the next 22 bits in the long object pointer are an index into a bounds-information table, while the remaining 40 bits are the address of an object. Further still, a tag value of “11” may be used to indicate that the next (e.g., immediately adjacent) 62 bits of the long object pointer are an address, and the following 64 bits are an index to an entry in the bounds-information table.

Accordingly, sub-operation 654 includes determining whether the predetermined bit (or set of bits) in the long object pointer has a first value that indicates the pointer includes unused bits (e.g., don't care bits) therein. In other words, sub-operation 654 determines whether the index and the object address are stored in different portions of the pointer. In response to determining the predetermined bit (or set of bits) does have a first value indicating that the index and the object address are stored in different portions (e.g., halves) of the long object pointer, the flowchart proceeds from sub-operation 654 to sub-operation 656. There, sub-operation 656 includes extracting the index of the entry from the second 64 bits of the object pointer, and sub-operation 657 includes extracting the address of the object from the first 64 bits of the object pointer. The extracted index of the entry may thereby be used to access bounds information from the bounds information table as illustrated in step 614.

An exemplary representation 660 of the information that may be included in a long object pointer determined as having index information and the object address in different 64 bit sections is illustrated in accordance with another approach. Specifically, the predetermined bit 661 is shown as having a value of “1”. The address of an object is stored in remaining ones of the first 64 bits 662 of the object pointer, and a second 64 bits 664 of the object pointer is used to store an index of an entry in a bounds-information table that corresponds to the object. It follows that the representation 660 outlines how index information and the object address may be organized in a long 128 bit object pointer, e.g., according to one approach.

However, the flowchart proceeds from sub-operation 654 to sub-operation 658 in response to determining that the predetermined bit does not indicate the index and the object address are stored in different portions (e.g., halves) of the long object pointer. In other words, the flowchart proceeds to sub-operation 658 in response to determining that the index and the object address have been combined and are stored in a same portion (e.g., half) of the full long object pointer. There, sub-operation 658 includes extracting the index information, as well as the address of the corresponding object, from the same 64 bits of the long object pointer.

An exemplary representation 668 of the information that may be included in a long object pointer determined as having index information and the object address in the same 64 bits is illustrated in accordance with one approach. Specifically, the predetermined bit 670 is shown as having a value of “0,” as a second grouping of 64 bits is effectively unused. Thus, the first portion of the long object pointer may be used to store the address of an object 672 as well as an index 674 of an entry in a bounds-information table that corresponds to the object. Moreover, the second portion of the long object pointer may be filled with don't care bits 676 (e.g., any desired values) which serve as placeholders but are not used to perform the bounds-checking, e.g., as would be appreciated by one skilled in the art after reading the present description. It follows that the representation 668 outlines how index information and the object address may be organized in a long 128 bit object pointer, e.g., according to one approach.

The index information that is extracted from the long object pointer may thereby be used to perform one or more of the operations in FIG. 6A, e.g., as described above. As a result, approaches herein are able to further improve efficiency by reducing the amount of information is fetched from (and/or stored to) memory, copied from one register to another when a pointer is assigned in an assignment statement, passed in a function call, or used to compute another address in array indexing or pointer arithmetic, etc. It follows that performance may further be improved by selectively combining index and object address information in a same portion (e.g., half) of the long object pointer.

It follows that the various operations of method 600 are desirably able to achieve a low-cost and minimally invasive framework for bounds-checking in hardware by implementing long object pointers having a length of 128 bits or more as described herein. Method 600 achieves a hardware-enabled pointer for bounds-checking framework that is able to perform low-cost, yet precise enforcement of memory safety for heap-objects. Moreover, the size of the object pointers used to perform the bounds-checking is sufficiently large that the approaches herein may support applications of extremely large size. Again, using object pointers that are 128 bits in length allows for a very large number of objects to coexist without overlapping. Furthermore, the techniques disclosed in the approaches herein facilitate mitigating memory-errors for heap-objects using precise enforcement of object-bounds on pointer-dereferences, to prevent out-of-bounds access and use-after-free errors. The disclosed techniques facilitate precise enforcement of such object-bounds while ensuring minimal performance impact and can be implemented with minor or no changes to source-code or binary layout.

As noted above, some approaches may utilize any unused bits in the long object pointer to track additional information that is related to the object, the entry in the bounds-information table, a corresponding instruction that uses the object pointer, etc. For instance, some approaches employ unused bits in long 128 bit object pointer to track a range of addresses in the memory that can be accessed. This additional information may also be utilized to perform determinations, location requests, data write operations, etc. It may thereby be desirable to propagate the additional information in response to the object pointer being copied in an assignment statement, e.g., as would be appreciated by one skilled in the art after reading the present description.

Another aspect of the disclosed techniques involves expanding the approaches described herein past being applied to heap objects. For instance, the extensions discussed here may be extended to provide memory-safety protection for global and stack objects in some approaches. While some approaches herein are described in the context of 128 bit pointers, protection for stack objects and global objects as described in the present disclosure is also applicable to 64 bit pointers, e.g., as would be appreciated by one skilled in the art after reading the present description. Moreover, this memory-safety protection can be added with additional “compiler” support. For instance, the compiler can add code to allocate/free entries in a bounds-information table for stack objects at the beginning and end of a function. And an index to an entry in the bounds-information table may be added into the address expression of a newly allocated object on the stack. The compiler may also be able to add code which allocates entries in the bounds-information table for the global objects at a linkage step. In some approaches, the index can be encoded into global symbols.

Another aspect of the disclosed techniques involves extending the memory-safety protection for “simple” arrays and structs, to provide finer-grained memory-safety protection. This can protect the other portions of a struct from a “buffer overflow” in a string within the struct for example. For example, in the following code:

```
struct a {
  int x;
  char s[20];
  int y;
};
```

This finer-grained protection can be provided when a “struct a” is instantiated by creating an additional bounds table entry that has the lower and upper bounds of the newly instantiated character array s and inserting the index of this new bounds table entry into the address of the newly instantiated character array s to prevent a strcpy from or to s from going beyond the bounds of array s. The compiler can add code that does this when a struct a is instantiated. The compiler can also add code that invalidates this additional bounds table entry when a struct a is freed to prevent a “use-after-free” error (also known as a “dangling pointer” error) that might otherwise occur if string s is used after the struct is freed.

Another aspect of the disclosed techniques involves protecting the integrity of the index bits from an arithmetic overflow that might otherwise corrupt the integrity of the index bits. For the integrity of the index bits in a pointer, a threat model is considered in which it is assumed that: i) the program to be protected is not malicious, ii) the adversary cannot make arbitrary changes to the program's code or data, and iii) the adversary can provide inputs to the program that, if not properly validated, can take advantage of memory-safety vulnerabilities within the program (e.g., such as out-of-bounds references).

According to an example, an adversary could attempt taking advantage of a memory-safety vulnerability in a calendar program by attempting to access or update a calendar entry for a particular date. If the program does not properly validate its input, the program could compute the address for this calendar entry by adding a large number to the calendar's base address and attempt a load or store at this address. However, the addition of this large number could “overflow” into and corrupt the index bits of the computed address which could compromise the bounds-check on the load or store. This problem can be overcome because the compiler already knows when arithmetic is being performed on a pointer. The compiler already knows the amount that a pointer needs to be incremented by in order to perform array indexing or pointer arithmetic. Thus, the compiler can use a special add instruction (or a special mode of an add instruction) for pointer arithmetic or array indexing. The special pointer-add instruction may also be designed such that arithmetic doesn't overflow into the index bits.

Another aspect of the disclosed techniques involves further reducing false-negatives on use-after-free errors (also referred to also “dangling pointer errors”). As discussed above, approaches herein are able to detect and prevent “out-of-bounds” memory references as well as “use-after-free” errors by implementing a bounds-check process. The bounds-check involves using the index to lookup the corresponding entry in a bounds table, obtaining the base and size of the object, and asserting that the access is within [base, base+size]; otherwise, an out-of-bounds exception is triggered. However, in situations where the entry base and size are 0, a use-after-free exception is raised. Moreover, if the entry is reused, a dangling pointer access remains detected due to mismatch in bounds with a high probability but flagged as an out-of-bounds exception.

To further increase the probability of detecting a use-after-free error, approaches herein keep the [base, base+size] values in the bounds table entry even in response to an object being freed. Moreover, one bit in the entry is used to indicate that the entry has been freed. According to an example in which objects are typically allocated at addresses that have a least significant bit of ‘0’, a ‘1’ in the least significant bit of the base address could be used to indicate that an entry has been freed. Moreover, a newly allocated object may be assigned to either an unused bounds table entry, or a freed bounds table entry that has base and bounds that do not overlap those of the new object.

For example, a predetermined one or more bits of each entry (or at least some entries) in a bounds-information table may be used to identify whether the corresponding entry is currently free (e.g., unused). This desirably avoids situations where entries that are in use are unintentionally reassigned to new objects. It follows that the process of allocating a new object in memory may involve selecting an entry in the bounds-checking table with a predetermined bit having a value that indicates the selected entry is currently free. The selected entry may thereby be assigned to the New object. Moreover, the value of the predetermined bit in the selected entry is preferably updated to indicate the entry is now in use and no longer free.

The likelihood of experiencing a false negative can be further reduced by keeping a list of base and size pairs that have been used with each index value. This information may be used in response to a new object being allocated so that the new object can be assigned an index value that has not been used by the other objects that previously used memory allocated to the new object. In this way, any dangling pointer references to the “old” objects will generate an out-of-bounds exception rather than silently (and erroneously) reading or writing the new object's memory.

Another aspect of the disclosed techniques involves reducing bounds table management overhead for stack objects. Objects (arrays and structs) that are local to a function are allocated “automatically” on the stack in response to the function being called, and are de-allocated in response to the function being returned. It follows that bounds table entries may be created each time a function is called, and deleted each time a function is returned. A function that is called frequently may thereby result in a significant amount of time and compute power dedicated to managing entries in the bounds table. Resources consumed by performing bounds table management can be reduced for functions that are not recursive by converting “automatic” arrays and structs, to “static”. Static variables are allocated only once rather than every time a function is called, and therefore the bounds table entries for these static objects will be created only once.

Another aspect of the disclosed techniques involves reducing runtime overhead when the compiler can determine that runtime checks are not needed for certain objects. For example, in the following code:

```
some_function( ){
  int a[BIG_NUMBER];
    ...
  for (i = 0; i < BIG_NUMBER; i++){
        ...
      < code that reads and writes a[i] >
        ...
  }
    ...
}
```

The compiler may be able to determine at compile time that run-time memory-safety checks to array a are not needed. And the compiler can compile the code in a way that does not create or delete a bounds table entry for array a.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A computer-implemented method (CIM), comprising:
generating an entry in a bounds-checking table, wherein the entry includes bounds-information that corresponds to an object allocated in memory of a memory device;
writing an address of the object in a first 64 bits of an object pointer;
writing an index of the entry in a second 64 bits of the object pointer, wherein the object pointer includes 128 bits;
intercepting an instruction that uses the object pointer to load information from or store information to memory; and
using the bounds-information to execute bounds-checking by:
extracting the index of the entry from the second 64 bits of the object pointer, and
using the extracted index to access the bounds-information from the entry.

2. The CIM of claim 1, wherein the using of the bounds-information to execute bounds-checking further includes:
using the bounds-information to determine whether a reference to an object is in-bounds or out-of-bounds; and
in response to determining that a reference to an object is out-of-bounds, preventing the out-of-bounds reference.

3. The CIM of claim 1, wherein the using of the bounds-information to execute bounds-checking further includes:
checking a predetermined set of one or more bits in the 128 bit object pointer; and
in response to the predetermined set of bits having a first value, extracting the index of the entry from the second 64 bits of the object pointer.

4. The CIM of claim 3, wherein the using of the bounds-information to execute bounds-checking further includes:
intercepting a second instruction that uses a second 128 bit object pointer to load information from or store information to memory;
checking a predetermined set of one or more bits in a second object pointer; and
in response to the predetermined set of bits in the second object pointer having a second value, extracting an index of a corresponding second entry in the bounds-checking table from a first 64 bits of the second object pointer.

5. The CIM of claim 4, wherein the first 64 bits of the second object pointer includes:
an address of a corresponding second object, and
the index of the second entry.

6. The CIM of claim 5, wherein the second 64 bits of the second object pointer includes:
don't care bits.

7. The CIM of claim 1, further comprising:
in response to the object being freed from the memory, updating a value of a predetermined set of bits in the entry to indicate the entry is currently free.

8. The CIM of claim 7, wherein allocating a new object in the memory of the memory device includes:
selecting an entry in the bounds-checking table having a value in the predetermined set of bits that indicates the selected entry is currently free;
assigning the selected entry to the new object; and
modifying the value of the predetermined set of bits in the selected entry to indicate the selected entry is not currently free.

9. The CIM of claim 1, further comprising:
employing unused bits in the 128 bit object pointer to track additional information, including a range of addresses in the memory that can be accessed; and
propagating the additional information in response to the object pointer being:
copied in an assignment statement, passed in a function call, or used to compute another address in array indexing or pointer arithmetic.

10. A computer program product (CPP), comprising:
a set of one or more computer-readable storage media; and
program instructions, collectively stored in the set of one or more storage media, for causing a processor set to perform the following computer operations:
generate an entry in a bounds-checking table, wherein the entry includes bounds-information that corresponds to an object allocated in memory of a memory device;
write an address of the object in a first 64 bits of an object pointer;
write an index of the entry in a second 64 bits of the object pointer, wherein the object pointer includes 128 bits;
intercept an instruction that uses the object pointer to load information from or store information to memory; and
use the bounds-information to execute bounds-checking by:
extracting the index of the entry from the second 64 bits of the object pointer, and
using the extracted index to access the bounds-information from the entry.

11. The CPP of claim 10, wherein the using of the bounds-information to execute bounds-checking further includes:
using the bounds-information to determine whether a reference to an object is in-bounds or out-of-bounds; and
in response to determining that a reference to an object is out-of-bounds, preventing the out-of-bounds reference.

12. The CPP of claim 10, wherein the using of the bounds-information to execute bounds-checking further includes:
checking a predetermined set of one or more bits in the 128 bit object pointer; and
in response to the predetermined set of bits having a first value, extracting the index of the entry from the second 64 bits of the object pointer.

13. The CPP of claim 12, wherein the using of the bounds-information to execute bounds-checking further includes:
intercepting a second instruction that uses a second 128 bit object pointer to load information from or store information to memory;
checking a predetermined set of one or more bits in a second object pointer; and
in response to the predetermined set of bits in the second object pointer having a second value, extracting an index of a corresponding second entry in the bounds-checking table from a first 64 bits of the second object pointer.

14. The CPP of claim 13, wherein the first 64 bits of the second object pointer includes:
an address of a corresponding second object, and
the index of the second entry.

15. The CPP of claim 14, wherein the second 64 bits of the second object pointer includes:
don't care bits.

16. The CPP of claim 10, wherein the program instructions are for causing the processor set to further perform the following computer operations:
in response to the object being freed from the memory, update a value of a predetermined bit in the entry to indicate the entry is currently free.

17. The CPP of claim 16, wherein allocating a new object in the memory of the memory device includes:
selecting an entry in the bounds-checking table having a value of the predetermined bit that indicates the selected entry is currently free;
assigning the selected entry to the new object; and
modifying the value of the predetermined bit in the selected entry to indicate the selected entry is not currently free.

18. A computer system (CS), comprising:
a processor set;
a set of one or more computer-readable storage media;
program instructions, collectively stored in the set of one or more storage media, for causing the processor set to perform the following computer operations:
generate an entry in a bounds-checking table, wherein the entry includes bounds-information that corresponds to an object allocated in memory of a memory device;
write an address of the object in a first 64 bits of an object pointer;
write an index of the entry in a second 64 bits of the object pointer, wherein the object pointer includes 128 bits;
intercept an instruction that uses the object pointer to load information from or store information to memory; and
use the bounds-information to execute bounds-checking by:
extracting the index of the entry from the second 64 bits of the object pointer, and
using the extracted index to access the bounds-information from the entry.

19. The CS of claim 18, wherein the using of the bounds-information to execute bounds-checking further includes:
checking a predetermined set of one or more bits in the 128 bit object pointer;
in response to the predetermined set of bits having a first value, extracting the index of the entry from the second 64 bits of the object pointer;
intercepting a second instruction that uses a second 128 bit object pointer to load information from or store information to memory;
checking a predetermined set of one or more bits in a second object pointer; and
in response to the predetermined set of bits in the second object pointer having a second value, extracting an index of a corresponding second entry in the bounds-checking table from a first 64 bits of the second object pointer.

20. The CS of claim 19, wherein the first 64 bits of the second object pointer includes: an address of a corresponding second object, and the index of the second entry, wherein the second 64 bits of the second object pointer includes don't care bits.
